(19) United States
(12) Patent Application Publication
(10) Pub. No.: US 2002/0171753 A1
(43) Pub. Date: Nov. 21, 2002

(54) Method and device for controlling quantity of light from flash lamp externally attached to digital camera

(76) Inventor: Yoshiyuki Takematsu, Tokyo (JP)

Correspondence Address: BEYER WEAVER & THOMAS LLP, P.O. BOX 778, BERKELEY, CA, 94704-0778, US

(21) Appl. No.: 10/117,972

(22) Filed: Apr. 4, 2002

(30) Foreign Application Priority Data
Apr. 13, 2001 (JP) 2001-116199

(51) Int. Cl. H04N 5/222

(52) U.S. Cl. 348/370

(57) ABSTRACT

A digital camera has an internally provided flash lamp and an externally attached flash lamp. The internally provided flash lamp is controlled to effect a preliminary emission of light and thereafter a principal emission of light. The externally attached flash lamp emits light, triggered by light from the internally provided flash lamp. A control device is provided to control the light emission from the externally attached flash lamp in response to the primary emission of light from the internally provided flash lamp such that enough energy will be left in the main capacitor for supplying power to the externally attached flash lamp such that a sufficient quantity of light can be emitted in response to the principal emission of light from the internally provided flash lamp.

### BACKGROUND OF THE INVENTION

This invention is in the technical field of controlling the quantity of light from a flash lamp externally attached to a digital cameral.

FIG. 1 shows a digital camera (herein also referred to simply as a “camera”) 1 used for underwater photography, being contained inside a watertight housing 4. Since there is generally less light available in an underwater environment, a stroboscopic lamp (herein referred to as a “flash lamp”) is more frequently used by an underwater photographer. If an internally provided flash lamp (“inner lamp”) 2 is used, however, the emitted flash light is reflected by dust particles floating in water because the light emitting element of the inner lamp 2 is positioned close to the lens 3 of the camera 1, producing white spots in the image and thereby giving rise to the so-called marine snow phenomenon. If a wide conversion lens with a large outer diameter is attached to the front frame 7 of the housing 4, on the other hand, the emitted light from the inner lamp 2 tends to be screened by the wide conversion lens, and a dark spot may appear on the target object to be photographed.

An externally attached flash lamp (“outer lamp”) 9 is used in view of these problems, attached to the camera housing 4. In order to prevent the occurrence of a marine snow phenomenon, it has been known to attach a back light screening plate 6 or a tape on the front surface of a diffusion plate 5 on the housing 4. Such an outer lamp 9 is used also when the distance to the target object is large and the light from the inner lamp 2 is not enough.

On the land, as inside water, an outer lamp 9 may be similarly used when the light from the inner lamp 2 is not sufficient although the waterproof housing 4 is not necessary unless there are many water drops in the environment.

The outer lamp 9 must be synchronized with the inner lamp 2. A simple synchronization method without using an electric chord between them is to detect the light from the inner lamp 2 by means of a photodetector sensor 10 for the outer lamp 9. Since the light from the inner lamp 2 normally reaches the sensor 10 dependably, there is no need to provide any particular light transmitting means. If the distance between the light emitting part of the inner lamp 2 and the outer lamp 9 is large or if there is a source of external disturbance, however, an optical fiber 8 may be used as shown in FIG. 1 to connect the light emitting part of the inner lamp 2 and the sensor 10 such that the light from the inner lamp 2 can be received by the sensor 10 dependably.

There are the following two methods of controlling the quantity of light from the inner lamp of a digital camera. One is by causing a weak preliminary emission of light immediately before the shutter is opened, measuring the reflected light by a sensor through the camera lens to determine the required quantity of light, and causing the determined quantity of light to be emitted as the principal emission as the shutter is opened. The other is by causing light to be emitted only once as the shutter is opened, integrating signals of reflected light detected by a sensor of the camera and stopping the emission as the integrated total quantity of light reaches a specified level. Both kinds have been in use but the former type is becoming overwhelmingly more popular for digital cameras because of the ease of control.

FIG. 2 shows the mode of light emission when a prior art flash lamp or a manual flash lamp is externally attached to a digital camera of the kind described above. FIG. 2A shows the operation of the shutter and FIG. 2B shows the light emission from the inner lamp 2, numeral 11 indicating the weak preliminary emission of light for determining the required quantity of light for the principal emission. The light emission from the outer lamp 9 is triggered as the preliminary emission 11 from the inner lamp 2 is guided to the sensor 10 but the triggered outer lamp 9 may emit a normal large quantity of light such that there is not enough energy left for it to emit a sufficient quantity of light, or to emit any light at all, in synchronism with the opening of the shutter. This situation happens especially if the distance between the camera and the target object is large.

In order to avoid such a situation, it has been known to provide a so-called preliminary emission canceling circuit for preventing the outer lamp from emitting light at the time of the preliminary light emission from the inner lamp and allowing the outer lamp to emit light only at the time of the principal light emission from the inner lamp. FIG. 2C shows the light emission 13 from the outer lamp thus controlled, starting at time T1 and ending at time T2 when the total quantity of light emitted reaches a specified level. The broken line portion of FIG. 2C shows how the emission would proceed if it were not stopped.

According to the prior art technology explained above with reference to FIG. 1, the back light screening plate 6 or a tape covers the front surface of the diffusion plate 5 on the camera housing 4. Thus, the light from the inner lamp 2 does not reach the target object and hence is not reflected back. A similar result is obtained also when a conversion lens or another accessory with a large external diameter is attached.

Cameras according to prior art technology conclude that the target object is at a large distance if no reflection of preliminarily emitted light is received or the quantity of reflected light is smaller than normal and do not stop the principal emission from the inner lamp 2. The principal emission of light from the inner lamp 2 is then a “full emission” as shown by the solid line 12a in FIG. 2B. The time of full emission from the inner lamp is usually about 3 milliseconds.

After such a full emission, the capacitor for the inner lamp 2 must be recharged, and it usually takes 7-8 seconds with an ordinary camera. This means that the shutter of the digital camera becomes “locked”. It also means that the battery for the camera is consumed accordingly more, adversely affecting the number of pictures that can be taken without replacing it with a new one.

Time for calculating photographic data and time for recording in a memory are also required but some cameras are designed not to be able to perform such processes while there is a drop in the voltage of the battery, and this means that the user cannot take the next picture in the meantime.

In the absence of an outer lamp, if the distance to the target object is between about 0.5 m and 3 m, the emission of light from the inner lamp is not a full emission but its principal emission becomes as shown by the broken line 12b in FIG. 2B. In other words, the quantity of emitted light is smaller and hence no time is required for recharging the capacitor, allowing the user to take the next picture immediately.

### SUMMARY OF THE INVENTION

It is therefore an object of this invention to provide a method and device for controlling the quantity of light from an externally attached flash lamp of a digital camera such that the quantity of light emitted as principal emission from the internally provided flash lamp can be reduced and that the wait time required until the next picture can be taken can be reduced and the useful lifetime of the battery can be improved.

A method embodying this invention may be characterized as comprising the steps of providing means for causing a first emission of light from the externally provided flash lamp in response to the primary emission of light from the internally provided flash lamp and controlling this emission of light such that enough energy is left in the main capacitor for supplying power to the externally attached flash lamp with a specified quantity of light required for the occasion.

A control device embodying this invention may be similarly characterized as comprising not only usual components of a flash lamp such as a DC-DC converter for charging the main capacitor for supplying power to the externally attached flash lamp, a so-called READY circuit for indicating that the main capacitor is charged and ready to be used, a trigger circuit for causing emission of flash light from a discharge tube and a gate voltage generating circuit for generating a timing signal for adjusting the timing of operations of the externally attached flash lamp, but also means for causing a first emission of light from the externally provided flash lamp in response to the primary emission of light from the internally provided flash lamp and controlling this emission of light such that enough energy is left in the main capacitor for supplying power to the externally attached flash lamp with a specified quantity of light required for the occasion.

A control device according to another embodiment may be characterized as comprising two discharge tubes and two respectively corresponding main capacitors, one of the discharge tubes used for a first emission in response to the preliminary emission from the internally provided flash lamp and there being a control means for controlling the emission of light from the other of the discharge tubes with a required quantity of light at the time of the principal emission of light from the internally provided flash lamp.

The invention also teaches the use of means for generating a stopping signal for stopping the first emission from the externally attached flash lamp. This may be done by one or more of the following steps of or means for (1) using differential signals obtained by differentiating signals which are indicative of the preliminary emission of light, (2) using integrating signals obtained by integrating signals which are indicative of the preliminary emission of light, (3) using a timer circuit for counting time of the preliminary emission of light, and (4) using a stop signal which causes the preliminary emission of the internally provided flash lamp. Additionally, use may be made of automatic stop signal generating means, automatic stop signal generating means, inhibiting means for the time of the preliminary emission, and a switching circuit for adjusting the quantity of light of the preliminary emission.

### BRIEF DESCRIPTION OF THE DRAWINGS

FIG. 1 is a schematic diagram for showing how an external flash lamp is attached to a digital camera according to prior art technologies and also according to this invention.

FIG. 2, comprised of FIGS. 2A, 2B, 2C, 2D and 2D, is a timing chart for the shutter operation and the emissions of light from the internal and external flash lamps according to prior art technologies and also according to this invention.

FIG. 3 is a block diagram for the circuit structure of a flash lamp embodying this invention externally attachable to a digital camera.

FIGS. 4A, 4B, 4C, 4D, 4E and 4F, together referred to as FIG. 4, are timing charts of signals and waveforms for the emissions of light.

FIG. 5 is a more detail circuit diagram of a portion of FIG. 3.

FIG. 6 is a circuit diagram of a circuit as shown in FIG. 3 with an extra function.

FIG. 7 is a circuit diagram with another circuit structure.

FIGS. 8A, 8B, 8C, 8D, 8E and 8F, together referred to as FIG. 8, are timing charts of signals and waveforms corresponding to the circuit structure shown in FIG. 7.

FIG. 9 is a block diagram of a portion of a circuit with another structure embodying this invention.

### DETAILED DESCRIPTION OF THE INVENTION

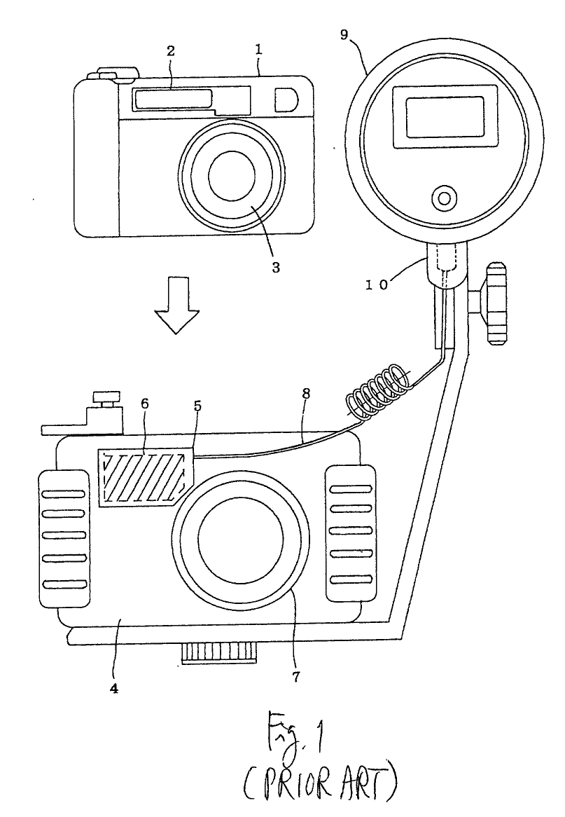

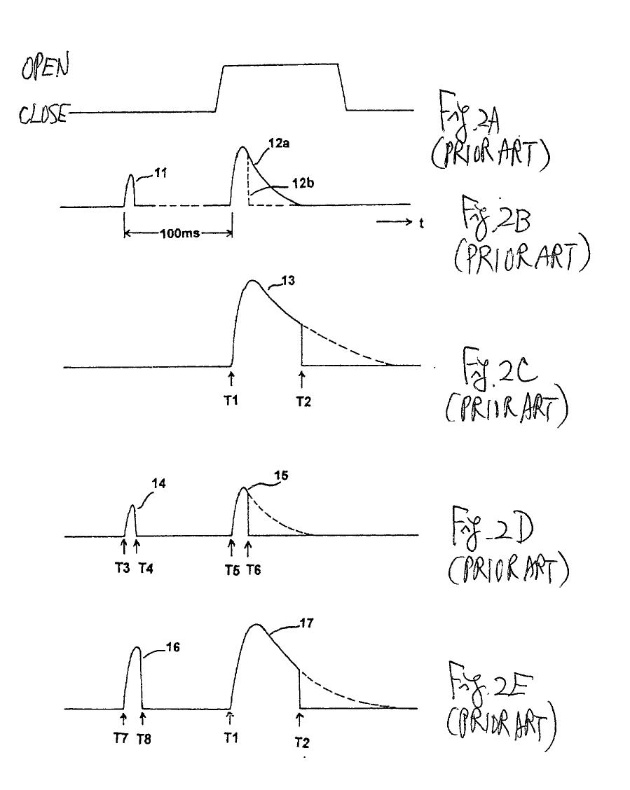

The invention is described next by way of an example. FIG. 3 is a circuit diagram, in part in the form of a block diagram, of a flash lamp (such as shown at 9 in FIG. 1 and referenced herein as the “outer lamp”) attached externally to a digital camera (such as shown at 1 in FIG. 1). Since this circuit structure is similar to that of an outer lamp of a commonly known kind, it will be described below only briefly.

Electrical power from a battery 18 is converted to a higher voltage of up to about 330V by means of a DC-DC converter (DC-DC) 20 including a rectifier diode 21 to charge a main capacitor 22. As the voltage of the main capacitor 22 increases gradually and reaches a certain specified level such as 260V, it serves to light up a neon tube contained in a voltage-detection circuit (the “READY circuit” 23) to thereby inform the user that the lamp is ready to be used. This lamp is normally referred to as the READY light or the READY lamp. Thereafter, a transistor 37 connected to a trigger circuit 24 becomes switched on, causing the trigger circuit 24 itself to be switched on. This causes a high-voltage pulse of about 3000V to be generated from a trigger coil to be applied to a discharge tube 26. It may be parenthetically remarked here that the use of the aforementioned voltage-detection circuit 23 is not a required element. The ready condition of the lamp may be indicated by detecting the voltage of the DC-DC converter circuit, and a light-emitting diode may be used instead of a neon tube.

When the lamp is to be controlled from outside, use is made of a shutter-operating terminal (sometimes known as the “X-junction”) 25. For establishing synchronism with the internally provided flash lamp (as shown at 2 in FIG. 1 and referenced as the “inner lamp”) of the camera 1, it is necessary to detect the light therefrom. It may be accomplished by transmitting a signal indicative of the principal light emission through a lead line from the shutter operating terminal or by converting this electrical signal into light by any known method and transmitting this light through an optical fiber connected to the outer lamp. These are practical methods because most digital cameras are provided with a shutter-operating terminal.

At the moment when the discharge tube 26 begins to emit flash light, an IGBT element 27 for controlling this light emission is in a switched-on condition. A control signal is synchronously emitted from the trigger circuit 24 and applied to a gate voltage generating circuit 19, causing it to simultaneously generate a gate voltage. A gate voltage may be provided alternatively from a discharge tube circuit. As the gate voltage is generated, either an automatic light emission control circuit 28 or a manual light emission control circuit 30 is operated, depending on the condition of a switch (an AUTO/MANUAL switch) 29. The gate voltage generating circuit 19 is for generating a timing signal for adjusting the timing of operation of the outer lamp 9. If the switch 29 is in the position as shown in FIG. 3, an automatic stop signal generating circuit 43 is activated when the discharge tube 26 emits light. This is carried out by a sensor 44 comprising a photo-transistor which receives light reflected from a target object, converts it to electrical signals and charges an integrating capacitor 45 therewith. The integrating capacitor 45 is connected to a comparator 47. When the voltage of the integrating capacitor 45 reaches a predetermined level (a comparison voltage divided by resistor 46), this indicates that an appropriate exposure has been made and the comparator 47 generates a signal which is applied to the automatic light emission control circuit 28. A light emission stopping signal is emitted thereupon from the automatic light emission control circuit 28 and applied to the IGBT element 27 which forms a part of a light emission control circuit. The IGBT element 27 is switched off and the discharge tube 26 ends its emission of light.

Numeral 48 indicates a control terminal for control from outside. It is used when automatic and manual stop signal generating circuits or their equivalents are disposed externally and also when a control signal for stopping the light emission is inputted from the camera.

When the AUTO/MANUAL switch 29 is switched to MANUAL, the gate voltage from the gate voltage generating circuit 19 is applied to the integrating capacitor 31a through a resistor. When this voltage reaches a predetermined level, the manual light emission control circuit 30 is switched on and a signal for stopping the light emission is applied to the IGBT element 27 such that the discharge tube 26 stops its emission of light.

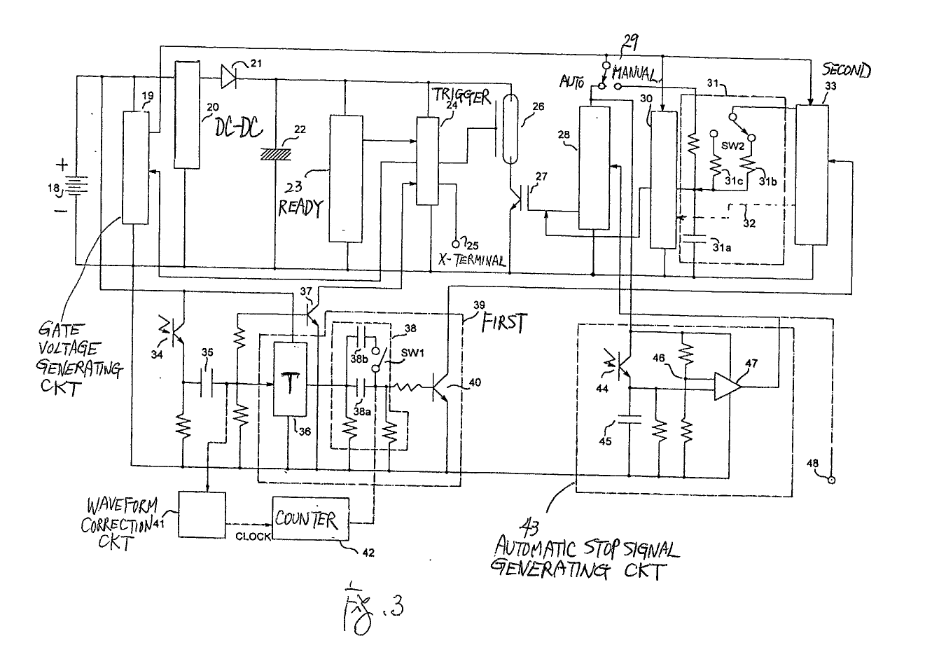

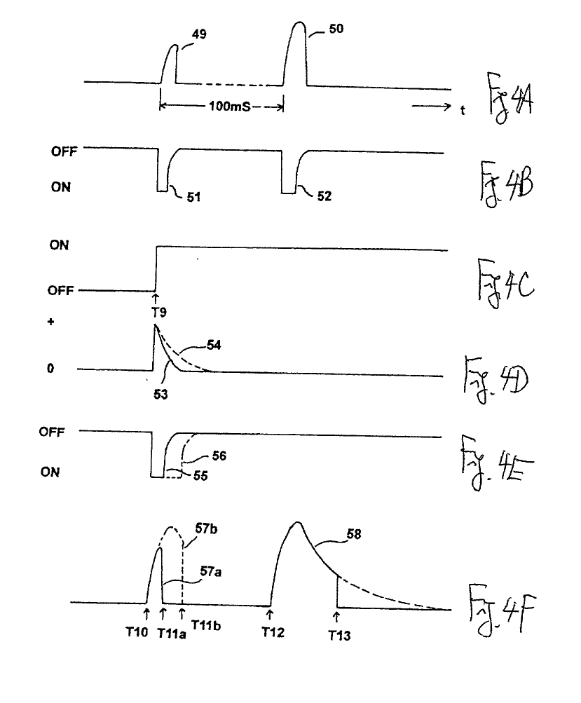

The structures and operations of various components of this invention will be described next with reference to FIGS. 3 and 4.

Since the outer lamp 9 embodying this invention is adapted to emit light by using the preliminary light emission from the inner lamp 2 of the digital camera 1 as the trigger, it requires a photodetector circuit including a photodetector sensor 10 and a preliminary light emission signal generating means including a first preliminary light emission signal circuit (“FIRST”) 39 and a second preliminary light emission signal circuit (“SECOND”) 33. The preliminary light emission signal generating means is for controlling the quantity of preliminarily emitted light to generate the signal for stopping the light emission.

When the shutter button of the digital camera 1 is pressed, the inner lamp 2 firstly emits a small quantity of light as preliminary light emission, as shown by waveform 49 in FIG. 4A. This preliminarily emitted light from the inner lamp 2 is detected by the photodetector sensor 10 which may comprise a phototransistor (as shown at 24) or its equivalent, and its signal is inputted through a capacitor 35 for cutting its DC portion to a timer circuit (“T”) 36 and a transistor 37. The photodetector sensor 10 comprising the photo-transistor 34 and the circuits near this photodetector sensor 10 may be a separate component not included in the outer lamp 9. Such structures are intended to be also included within the scope of this invention. For example, the photodetector sensor and its peripheral circuits may be disposed near the inner lamp 2 inside the camera 1 and a lead line may be used to connect them to the outer lamp 9. The signal may be converted into an optical signal and transmitted through an optical fiber. The output signal from the transistor 37 after the detection signal from the phototransistor 34 is inputted will be as shown by waveform 51 in FIG. 4B. As explained above, the trigger circuit 24 is activated, and the discharge tube 26 begins to emit flash light (“first emission”).

The timer circuit 36 contained in the first preliminary light emission signal circuit 39 is provided for detecting only the preliminary emission of light from the inner lamp 2 because it provides a most simple circuit structure.

It is to be remembered that the circuits for setting time disclosed herein are intended to be examples of time setting means. Integrating, differentiating and timer circuits described herein are not essential components of this invention but may be substituted with a one-shot multiple-purpose circuits, a latch circuit, other equivalent circuits and other digitized equivalent circuits for functioning similarly. In the case of a digitized method, a counter (such as a decimal counter) 42 may be used to retrieve a signal representing only the preliminary emission. Numeral 41 indicates a waveform correction circuit which may be inserted whenever it is considered necessary. Use may also be made of a microcomputer programmed according to the timing shown in FIG. 4, although the cost may be adversely affected. In such a case, other control circuits can also be controlled at the same time.

As a signal from the capacitor 35 is inputted to this timer 36, the timer 36 is switched on as shown in FIG. 4C. Since this timer 36 remains switched on for more than about 200 milliseconds, it is not influenced by the second light emission from the inner lamp 2 and serves to generate a signal for functioning only at the time of the preliminary light emission as shown in FIG. 4. In response to this signal, the first and second preliminary light emission signal circuits 39 and 33 function only at the time of the preliminary light emission.

The waveform shown in FIG. 4D is obtained if the output signal from the timer 36 is differentiated from the position of timing T9 shown in FIG. 4C by a differential circuit 38. If this signal is inputted to the transistor 40, the its collector terminal changes as shown in FIG. 4E. The signal width can be adjusted by varying the constants of the differential circuit 38. Eventually, the quantity of initially emitted light from the outer lamp 9 can be controlled.

Explained again with reference to FIGS. 3 and 4, waveform 53 of FIG. 4D is for the case of the standard capacitance, and waveform 54 shows a situation where the capacitance has been somewhat increased. Curves 55 and 56 of FIG. 4E are the corresponding waveforms of the transistor 40, and curves 57a and 57b of FIG. 4F show the corresponding quantities of light. In summary, the quantity of preliminarily emitted light can be increased and decreased by adjusting the capacitance and hence an optimum value can be selected according to the actual condition.

The corresponding circuit includes differential capacitors 38a and 38b, as shown in FIG. 3. The total capacitance increases if capacitor 38b is added to capacitor 38a. If a plurality of capacitors are provided together with a switch as shown at SW1 (herein also referred to as the “switching means”), the total capacitance can be conveniently adjusted according to the situation. Although an example is shown wherein the capacitance of a differential circuit is made variable, it is equally effective to vary the resistance of a resistor belonging to a differential circuit or making the base resistance of the transistor 40 variable.

The transistor 40 is connected to the second preliminary light emission signal circuit 33 and is adapted to have the aforementioned signals inputted thereto.

The function of the second preliminary light emission signal circuit 33 changes, depending on situations, as will be explained more in detail below. In all cases, however, it functions as a part of the means for stopping light emission by generating a signal therefor when a specified level is reached and applying this signal to the IGBT element 27 to switch it off and to cause the emission of light from the discharge tube.

Firstly (1), when it is desired to make the flash light emission time of the outer lamp at the time of preliminary light emission considerably longer than that of the inner lamp, a timer circuit or a similar circuit is connected to the second preliminary light emission signal circuit 33 to increase the ON-time (operating time) and then to the differential circuit 31. This is because the second preliminary light emission signal circuit 33 becomes switched off before the integrated value reaches a specified level unless the time for the second preliminary light emission signal circuit 33 to supply power to the integrating circuit 31 is made sufficiently long. FIG. 3 shows the integrating circuit 31 formed partially in common with the manual light emission control circuit 30, another equivalent circuit may alternatively be provided.

When the second preliminary light emission signal circuit 33 is switched on and the integrating capacitor 31a reaches a specified level, the manual light emission control circuit 30 is activated and a signal for stopping light emission is outputted and the discharge tube 26 stops its emission of light.

If it is desired to adjust the flash light emitting time from the outer lamp 9 at the time of the preliminary light emission, an integrating circuit 31 may be provided with several different C/R time constants such that a selection may be made therefrom by means of a switch (such as shown by symbol SW2 in FIG. 3), depending on the situation. The adjustment may be made in terms of resistance by switching between resistors 31b and 31c. If it is to be made in terms of capacitance, additional capacitors may be provided besides capacitor 31a.

Since the integrating circuit 31, when combined with the manual light emission control circuit 30, functions as an equivalent of a timing circuit, it may be regarded as a part of what may be herein referred to as a timer circuit. When made digital, in particular, this portion may be said to serve as a digital timer circuit or an equivalent thereof.

Secondly (2), when it is desired to make the flash light emission time of the outer lamp at the time of preliminary light emission about the same as or a little longer than that of the inner lamp, the second preliminary light emission signal circuit 33 is connected to the integrating circuit 31 only as a buffer circuit. In this case, the switched-on time of the second preliminary light emission signal circuit 33 is from waveform 55 to waveform 56 of FIG. 4E. The time for the integrating capacitor 31a to reach the specified level should be set within the switched-on time of the second preliminary light emission signal circuit 33. Operations thereafter are the same as in the case (1) described above.

Thirdly (3), if the flash light emission time of the outer lamp at the time of preliminary light emission is to be adjusted only by means of the differential circuit 38 and the transistor 40, the second preliminary light emission signal circuit 33 is directly connected to a portion of the manual light emission control circuit 30 as a buffer circuit without going through the integrating circuit 31, as shown by the broken line 32. The timing of the discharge tube 26 for stopping the emission of light in this case is as shown by curves 55 and 56 in FIG. 4E. The signal for stopping the emission of light is inputted from the second preliminary light emission signal circuit 33 to the IGBT element 27 and the discharge tube 26 stops its emission of light.

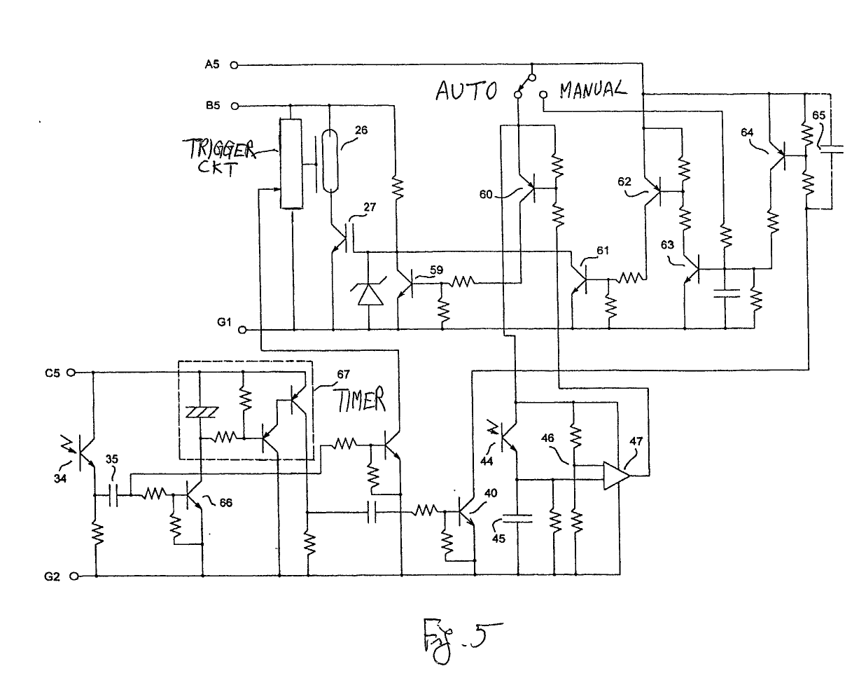

Explained with reference to FIG. 4, the discharge tube 26 begins to emit light at T10 in FIG. 4F and stops its emission of light at T11a of curve 57a corresponding to curve 55 of FIG. 5E or at T11b of curve 57b corresponding to curve 56 of FIG. 4E.

These operations for three situations at the time of the preliminary light emission (“first emission”) are carried out such that enough electrical power will be left in the main capacitor 22 for the principal light emission. Especially when the target object is at a large distance or the lens opening is narrow, a larger quantity of light is required for the principal light emission than for the preliminary emission. Explained more in detail, power from the main capacitor 22 is mostly used for the light emission from the outer lamp 9. So, if the outer lamp 9 undergoes a full emission or a nearly full emission, there may not be enough energy left in the main capacitor 22 for the occasion of the principal emission (“second emission”), resulting in an insufficient exposure or a failure to emit any light at all.

About 100 milliseconds after the operations as described above for a situation (1), (2) or (3), the inner lamp 2 of the camera 1 undergoes a principal light emission. Although the light from the inner lamp 2 does not reach the lens 3 of the camera 1 because it is screened, as explained above, the preliminarily emitted light from the outer lamp 9 (from curve 57a to curve 57b of FIG. 4F) is reflected by the target object (assumed to be at a distance between 0.5 m and 2 m) and makes incidence onto the lens 3 of the camera 1. As a result, the camera 1 is already aware that there is a target at a near distance, and the principal light emission of light from the inner lamp 2 is controlled such that the emission will be stopped in the middle as shown by waveform 50 in FIG. 4A. In other words, since there will be no full emission of light from the inner lamp 2, the object of controlling the quantity of light is hereby accomplished.

The principal emission of light from the inner lamp 2, thus controlled, is detected by the photodetector sensor 10 with the phototransistor 34, as explained above. The transistor 37 is thereby switched on as shown by waveform 52 in FIG. 4B, and the discharge tube 26 of the outer lamp 9 emits light as shown by waveform 58 shown in FIG. 4F. For this emission of light, neither the first nor second preliminary light emission signal circuit 39 or 33 is activated and no signal is outputted therefrom.

If the AUTO/MANUAL switch 29 is switched to AUTO, the automatic stop signal generating circuit 43 is activated. A signal for stopping the emission of light is outputted when a preliminarily determined level of appropriate exposure is reached, and the discharge tube 26 stops its emission of light and the series of operations comes to an end. Explained by way of FIG. 4, the emission of light is started at T12 in FIG. 4F and ends at T13. If the AUTO/MANUAL switch 29 is switched to MANUAL, the emission of light from the discharge tube 26 is similarly ended when the preliminarily determined level is reached and the series of operations comes to an end.

It has been ascertained that timing variations of some degrees in various operations described above do not seriously affect the quality of pictures taken by the camera. Thus, expressions such as “in synchronism” and “at the same time” within the context of this invention are allowed to be interpreted leniently. The timing charts in FIG. 4 should also be interpreted broadly. As an example, the preliminary emission of light does not involve a large quantity of light and its duration is only from about 20 to 50 microseconds. Thus, even if the emission of light from the outer lamp 9 is started after that from the inner lamp 2 is stopped, it can be considered sufficiently timely. In other words, a delay of this order of magnitude is no problem. The emission of light from the outer lamp 9 may be started even by using as its trigger the signal for stopping the preliminary light emission from the inner lamp 2. Such a delay will not be appreciated visually.

The invention is described next further in detail with reference to FIG. 5. Conventionally known portions will be omitted and only portions embodying this invention will be described. Terminal A5 is connected to the gate voltage generating circuit 19 shown in FIG. 3 and terminal B5 is connected to the main capacitor 22 shown in FIG. 3. Terminals G1 and G2 are grounded terminals and are connected to the negative terminal of the battery 18. The positive terminal of the battery 18 is connected to a plus circuit C5.

Numeral 67 indicates a timer circuit, shown more in detail by way of an example, corresponding to the timer circuit 36 shown in FIG. 3. As transistor 66 is switched on by a signal for starting light emission, the capacitor in the timer circuit 67 is charged up, causing the timer to start its functions.

The portion corresponding to the second preliminary light emission signal circuit 33 includes transistor 64 and capacitor 65. The capacitor 65 is added when a timer is required. As explained above, this portion may function as a timer in various ways. In the example of FIG. 5, it is connected to the integrating circuit.

When this integrating circuit reaches a predetermined level, transistors 63, 62 and 61 are all switched on, causing the IGBT element 27 to be switched off and the discharge tube 26 to stop its emission of light.

If the integrating circuit is not required, as explained above, the collector of transistor 64 is connected to the base circuit of transistor 61.

If the AUTO/MANUAL switch 29 is switched to AUTO when a signal is received from the automatic stop signal generating circuit 43, transistors 60 and 59 are switched on, causing the IGBT element 27 to be switched off and stopping the emission of light from the discharge tube 26.

It is here to be noted that the automatic stop signal generating circuit 43 is activated both at the time of preliminary light emission and at the time of principal light emission of the inner lamp. If the distance to the target object at the time of the preliminary light emission is relatively short (such as 0.5 m) and the lens opening is relatively wide such as F2, the automatic stop signal generating circuit 43 may reach the predetermined level with a smaller quantity of light than that set by the signal circuit for the preliminary light emission, generating a stop signal and stopping the emission of light from the discharge tube 26. In other words, the quantity of preliminarily emitted light from the outer lamp 9 becomes smaller than the specified value.

As a practical matter, however, this phenomenon is not a serious problem. If the target distance is short and the lens opening is wide as stated above, although the quantity of reflected light from the target object is somewhat diminished at the time of the preliminary light emission, the quantity of light at the principal emission from the digital camera becomes smaller as long as reflected light returns from the target. Thus, no serious problem is to be expected even if no measure is particularly taken, but an addition of a simple circuit, as shown in FIG. 6, can eliminate the problem as described above even when adverse conditions happen together coincidentally.

The basic principle is to stop (inhibit) the action of the automatic stop signal generating circuit 43 for the outer lamp which emits light in synchronism with the preliminary light emission of the inner lamp or the automatic light emission control circuit 28 only during the time of the preliminary light emission. FIG. 6 is the same as FIG. 3 except for the addition of inhibit circuits.

A first inhibit circuit (“INHIBIT 1”) 89 is added for stopping the action of the automatic stop signal generating circuit 43 at the time of the preliminary light emission. With the circuit structure as shown in FIG. 6, the first inhibit circuit 89 is switched on when it receives a signal generated by the first preliminary light emission signal circuit 39, and the action of the automatic stop signal generating circuit 43 is stopped. A second inhibit circuit (“INHIBIT 2”) 86 is connected to the automatic light emission control circuit 28 through a wire 87 for stopping the operation of the latter. Either of these inhibit circuits can eliminate the problem described above.

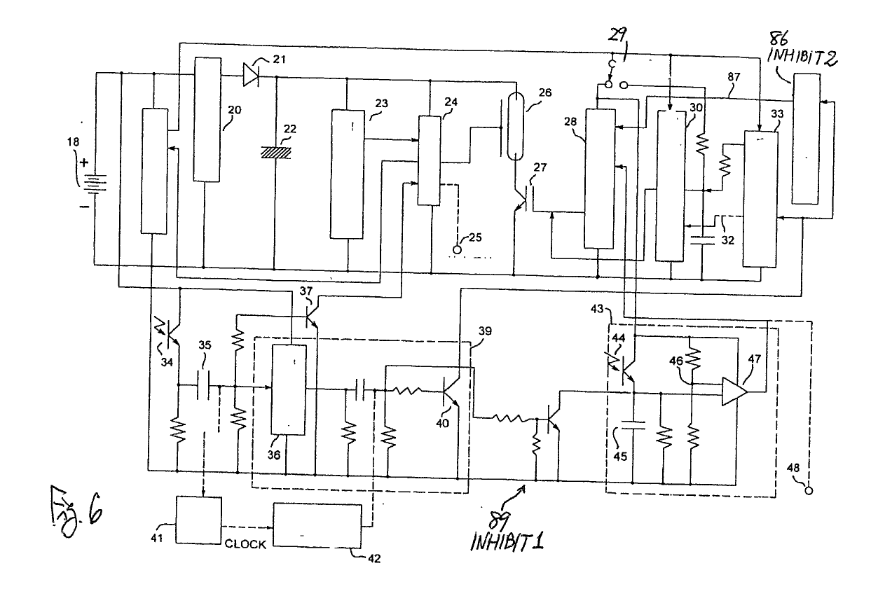

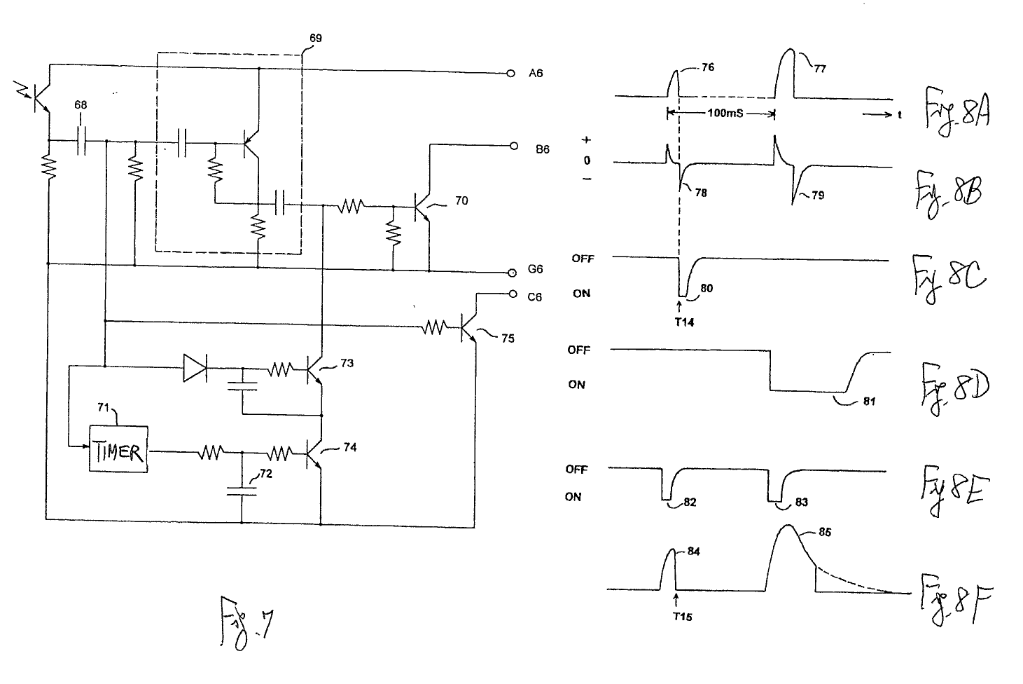

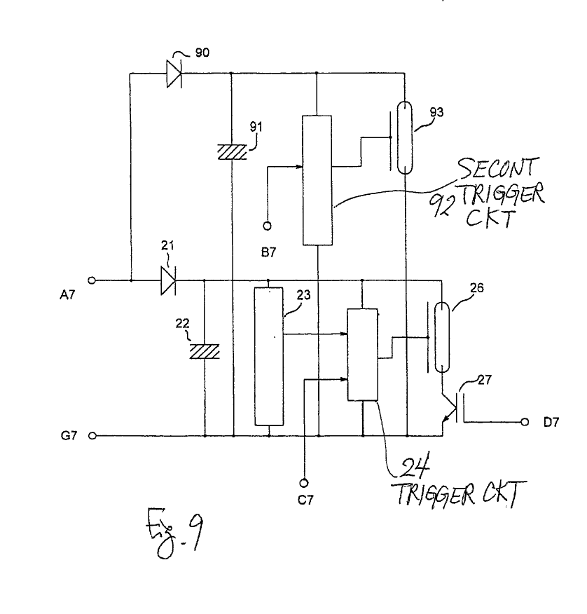

FIGS. 7 and 8 show another circuit structure for the first preliminary light emission signal circuit (shown at 39 in FIG. 3) functioning on another principle of matching the timing for stopping the preliminary emission of light from the inner lamp with that from the outer lamp. The remaining parts (not shown in FIG. 7) of the circuit structure for controlling the principal light emission are the same as explained above with reference to FIG. 3 and hence will not be repetitiously presented.

In FIG. 7, terminal A6 is connected to the positive terminal of a battery or an equivalent voltage level; terminal B6 is connected to the automatic light emission control circuit 28 of FIG. 3; terminal C6 is connected to the trigger circuit 24 of FIG. 3; and terminal G6 is a ground terminal connected to the negative terminal of a battery or an equivalent voltage level.

FIG. 8A shows the light emission from the inner lamp, curve 76 indicating its preliminary light emission. This signal is differentiated by capacitor 68 to produce a differential signal 78 shown in FIG. 6B. As this differential signal 78 is amplified by AC amplifier 69 and applied to transistor 70, a signal with waveform shown at 80 in FIG. 8C is obtained because transistor 70 is switched on only if its base is at a positive voltage. This signal 80 serves to stop the emission of light, being applied through the automatic light emission control circuit 28 to the IGBT element 27 of FIG. 3. As a result, the emission of light from the discharge tube 26 is stopped at the timing shown at T14 in FIG. 8C (and also at T15 in FIG. 8F). The quantity of light by the preliminary emission can be controlled by inserting a timer or an equivalent circuit on the upstream or downstream side of the transistor 70 to vary the timing T15 of stopping the light emission.

FIG. 8E shows the switching of transistor 75. It is switched on in synchronism with the preliminary and principal light emission of the inner lamp (shown at 76 and 77) to activate the trigger circuit 23, causing the (first and second) emissions of light from the outer lamp with waveforms 84 and 85 shown in FIG. 8F.

The portion of the circuit shown in FIG. 7, including a timer circuit 71, an integrating capacitor 72 and transistors 73 and 74, is an inhibit circuit for inhibiting the operation of transistor 70 at the time of the principal emission of light. If this circuit were not provided, a pulse signal (shown at 79 in FIG. 8B) in synchronism with the stopping of light emission from the inner lamp for the second time (shown at 77 in FIG. 8A) would be applied to transistor 70 and the emission of light from the outer lamp would be stopped. This inhibit circuit serves to prevent transistor 74 from becoming switched on at T14 shown in FIG. 8 at the time of the preliminary light emission by means of the timer circuit 71 and the integrating capacitor 72.

At the time of the principal light emission thereafter, transistors 73 and 74 are switched on, and signal 81 shown in FIG. 8D is applied to the base of transistor 70, thereby inactivating transistor 70. Thus, the outer lamp becomes unaffected by the stopping of the principal emission of light from the inner lamp.

The preliminary light emission from the inner lamp may take place not only once but also for the second or third time. Even in such a situation, the timing of the inhibit circuit may be adjusted for synchronism. This circuit structure described above is convenient because the emission of light from both the inner and outer lamps can be stopped nearly simultaneously and hence the overall control becomes easier.

FIG. 9 shows still another circuit structure for the first preliminary light emission signal circuit (shown at 39 in FIG. 3) functioning on still another principle by providing a second main capacitor 91. FIG. 9 shows the discharge tube separately but this is for the clarity of explanation and the number of discharge tubes is not intended to limit the scope of the invention.

With reference to FIG. 9, terminal G7 is a ground terminal and is connected to the negative circuit of a battery; terminal A7 is connected to the DC-DC converter 20 shown in FIG. 3; and terminal D7 is connected to the automatic light emission control circuit 28 and the manual light emission control circuit 30. In this example, the first preliminary light emission signal circuit 39 and the second preliminary light emission signal circuit 33 of FIG. 3 are not required. Terminal B7 is connected to transistor 37. Terminal C7 is connected to the aforementioned preliminary emission canceling circuit of a known type such that it can be activated only at the time of the principal light emission.

The second main capacitor 91 is charged with power from the DC-DC converter 20 through another rectifier diode 90. The capacitance of the second main capacitor 91 is smaller than that of the first main capacitor 22, being about ⅕ to 1/10 of the latter and hence giving rise to a smaller quantity of light. The quantity of preliminary emission of light can thus be adjusted by increasing and decreasing this capacitance value.

A signal reaches terminal B7 first at the time of the preliminary emission of light from the inner lamp, activating a second trigger circuit 92 to cause a discharge tube 93 to emit light. A next signal arrives at the time of the principal light emission of the inner lamp but the discharge tube 93 does not emit light because the power of the second main capacitor 91 is almost all used up at the time of the preliminary light emission.

A signal comes to the trigger circuit 24 from terminal C7 only at the time of the principal light emission, activating the trigger circuit 24 to start the light emission from the discharge tube 26. This signal may be generated by a circuit of a known type such as a combination of a timer circuit and an integrating circuit or a digital circuit such as a counter circuit. A signal for stopping the emission reaches terminal D7 thereafter, as explained above, to switch off the IGBT element and to stop the light emission.

When two discharge tubes are used, as described above, they may be set at different positions. The discharge tube for the preliminary light emission may be placed near the camera while the discharge tube for the principal light emission may be set farther away.

Although FIG. 9 shows an embodiment wherein two discharge tubes are used, it is possible to use only the first discharge tube 26 to do way with the second trigger circuit 92. In such a situation, a switch circuit of a known type for cutting off the circuit for the first main capacitor 22 at the time of the preliminary light emission may be required for preventing interference. Alternatively, a circuit of another known type for connecting the circuit for the first main capacitor 22 at the time of the principal light emission may be required.

Although the circuit structure for the preliminary light emission may be thus different, the ratio of quantity of light between the preliminary and principal emission of light can be made similar to the example shown by FIG. 3 and similar effects can also be obtained.

According to this invention, in summary, the preliminary light emission from the outer lamp is started by using the preliminary light emission from the inner lamp as the trigger and the quantity of light by the principal emission from the inner lamp is controlled according to the reflection of the preliminarily emitted light from the outer lamp. Thus, the quantity of light from the inner lamp at the time of its principal emission can be reduced and the capacitor for the inner lamp can be more quickly recharged. This reduces the possibility of the user missing the chance of taking a desired picture. Additional advantages of this invention include a longer useful lifetime of the battery for the digital camera and hence that the battery need not be exchanged frequently.

The present invention is first characterized in that the preliminary light emission (“first emission”) of the outer lamp is controlled such that sufficient energy will be left in the main capacitor hence that the principal emission of light from the outer lamp (“second emission”) will not be adversely affected. Thus, the principal light emission from the outer lamp can be dependably effected with a sufficient quantity of light such that pictures of a high quality can be expected independent of the distance of the target object to be photographed.

The invention also teaches the preliminary emission of light from the outer lamp through a discharge tube connected to a main capacitor and the principal emission from the outer lamp through another discharge tube connected to another main capacitor, the principal emission from the outer lamp being stopped such that an appropriate quantity of light is emitted. This also assures that pictures of a high level of quality can be obtained dependably.

What is claimed is:

1. A method of controlling a digital camera having an internally provided flash lamp and an externally attached flash lamp, said internally provided flash lamp being controlled to effect a preliminary emission and thereafter a principal emission of light, said externally attached flash lamp having a main capacitor for supplying power for emission of light from said externally attached flash lamp, said method comprising the steps of:
providing light generating means for causing said externally attached flash lamp to effect a first emission of light in response to said preliminary emission by said internally provided flash lamp; and
controlling said first emission of light such that enough energy is left in said main capacitor for a second emission of light from said externally attached flash lamp with a specified quantity of light when said principal emission is effected.

2. The method of claim 1 wherein the step of controlling said first emission includes the step of generating a first emission stopping signal for stopping said first emission by one or more steps selected from the group consisting of the steps of:
using differential signals obtained by differentiating signals indicative of said preliminary emission of light;
using integrating signals obtained by integrating signals indicative of said preliminary emission of light;
using a timer circuit for counting time of said preliminary emission of light; and
using a stop signal which causes said preliminary emission of said internally provided flash lamp to stop.

3. The method of claim 1 wherein said second emission is automatically stopped by providing an automatic stop signal generating circuit for automatically generating a signal which causes said second emission to stop.

4. The method of claim 2 wherein said second emission is automatically stopped by providing an automatic stop signal generating circuit for automatically generating a signal which causes said second emission to stop.

5. A control device for controlling an externally attached flash lamp of a digital camera including an internally provided flash lamp, said internally provided flash lamp being controlled to effect a preliminary emission and thereafter a principal emission of light, said externally attached flash lamp including a main capacitor for supplying power, said control device comprising:
light generating means for causing said externally attached flash lamp to effect a first emission of light in response to said preliminary emission by said internally provided flash lamp; and
light emission controlling means for controlling said first emission of light such that enough energy is left in said main capacitor for a second emission of light from said externally attached flash lamp with a specified quantity of light when said principal emission is effected.

6. The control device of claim 5 wherein said externally attached flash lamp further includes:
a discharge tube;
a DC-DC converter for charging said main capacitor;
a voltage-detection circuit for indicating readiness of said capacitor for causing a discharge in said discharge tube; and
a trigger circuit for generating a voltage pulse and applying said voltage pulse to said discharge tube.

7. The control device of claim 5 wherein said light emission controlling means includes first emission stopping means for generating a first emission stopping signal for stopping said first emission by one or more steps selected from the group consisting of the steps of:
using differential signals obtained by differentiating signals indicative of said preliminary emission of light;
using integrating signals obtained by integrating signals indicative of said preliminary emission of light;
using a timer circuit for counting time of said preliminary emission of light; and
using a stop signal which causes said preliminary emission of said internally provided flash lamp to stop.

8. The control device of claim 5 further comprising automatic stop signal generating means for receiving light, converting the received light into electrical signals, processing said electrical signals to obtain a result, and outputting a stop signal for stopping emission of light from said externally attached flash lamp when said result reaches a predetermined value.

9. The control device of claim 7 further comprising automatic stop signal generating means for receiving light, converting the received light into electrical signals, processing said electrical signals to obtain a result, and outputting a stop signal for stopping emission of light from said externally attached flash lamp when said result reaches a predetermined value.

10. The control device of claim 8 wherein said automatic stop signal generating means incorporates inhibiting means for inhibiting said stop signal from being outputted when said preliminary emission is made.

11. The control device of claim 9 wherein said automatic stop signal generating means incorporates inhibiting means for inhibiting said stop signal from being outputted when said preliminary emission is made.

12. The control device of claim 5 further comprising switching means for selecting one of a plurality of predetermined quantities of light to be emitted at said second emission.

13. The control device of claim 7 further comprising switching means for selecting one of a plurality of predetermined quantities of light to be emitted at said first emission.

14. A control device for controlling an externally attached flash lamp of a digital camera including an internally provided flash lamp, said internally provided flash lamp being controlled to effect a preliminary emission and thereafter a principal emission of light, said control device comprising:
a first discharge tube and a second discharge tube;
a first main capacitor for supplying power to said first discharge tube for emission of light and a second main capacitor for supplying power to said second discharge tube for emission of light;
light generating means for causing said externally attached flash lamp to effect a first emission of light in response to said preliminary emission by said first discharge tube and a second emission of light in response to said principal emission by said second discharge tube; and
light emission controlling means for stopping said second emission of light when enough quantity of light specified by said camera as required for said second emission has been emitted.

15. The control device of claim 14 wherein said light emission controlling means includes first emission stopping means for generating a first emission stopping signal for stopping said first emission by one or more steps selected from the group consisting of the steps of:
using differential signals obtained by differentiating signals indicative of said preliminary emission of light obtained by integrating signals indicative of said preliminary emission of light;
using integrating signals obtained by integrating signals indicative of said preliminary emission of light;
using a timer circuit for counting time of said preliminary emission of light; and
using a stop signal which causes said preliminary emission of said internally provided flash lamp to stop.

16. The control device of claim 14 further comprising an automatic stop signal generating means for receiving light, converting the received light into electrical signals, processing said electrical signals to obtain a result, and outputting a stop signal for stopping emission of light from said externally attached flash lamp when said result reaches a predetermined value.

17. The control device of claim 15 further comprising an automatic stop signal generating means for receiving light, converting the received light into electrical signals, processing said electrical signals to obtain a result, and outputting a stop signal for stopping emission of light from said externally attached flash lamp when said result reaches a predetermined value.

18. The control device of claim 16 wherein said automatic stop signal generating means incorporates inhibiting means for inhibiting said stop signal from being outputted when said preliminary emission is made.

19. The control device of claim 17 wherein said automatic stop signal generating means incorporates inhibiting means for inhibiting said stop signal from being outputted when said preliminary emission is made.

20. The control device of claim 14 further comprising switching means for selecting one of a plurality of predetermined quantities of light to be emitted at said first emission.
